(19) United States
(12) Patent Application Publication
(10) Pub. No.: US 2013/0159131 A1
(43) Pub. Date: Jun. 20, 2013

(54) INTERACTIVE REQUEST FOR PROPOSAL AND RESPONSE ANALYSIS SYSTEM AND METHOD

(71) Applicant: MICHAEL J. WALKER, Chicago, IL (US)

(72) Inventor: MICHAEL J. WALKER, Chicago, IL (US)

(21) Appl. No.: 13/690,063

(22) Filed: Nov. 30, 2012

Related U.S. Application Data
(60) Provisional application No. 61/565,182, filed on Nov. 30, 2011.

(51) Int. Cl. G06Q 30/06

(52) U.S. Cl. CPC G06Q 30/0611; G06Q 30/0617
USPC 705/26.4

(57) ABSTRACT

An interactive request for proposal and response analysis system and method whereby a user may use a user workstation to access a list of subjective characteristics for buildings and enter user specific preferences for at least some of the subjective characteristics. An agent may use an agent workstation to select buildings for receiving requests for proposals, where the requests for proposals each includes the list of subjective characteristics, and send the requests for proposals to landlords for the buildings. The landlords may use at least one landlord workstation to receive and access the requests tor proposals and each landlord may enter a response for each subjective characteristic, where the entered responses for the subjective characteristics. The entered user specific preferences are compared with the entered landlord responses for the subjective characteristics for each of the plurality of buildings and a score is calculated for each building based on the comparison.

### CLAIM OF PRIORITY

This application claims priority to U.S. Provisional Patent Application No. 61/565,182. filed Nov. 30, 2011, the contents of which are hereby incorporated by reference.

### FIELD OF THE INVENTION

The present invention relates generally to commercial real estate leasing and, more particularly, to an automated request for proposal and proposal analysis system and method that incorporates a user's preferences with regard to subjective or intangible building features or qualities.

### BACKGROUND

in the commercial real estate industry, it is common for the user/tenant (“User”) to be represented by a broker that collects financial leasing information from various buildings for a User. Typically, the broker analyzes that information and presents it to the User in a written report so a decision can he made by the User on which building to lease. In this analysis, there are certain variables of landlord proposals that are very objective and quantitative and have the same value from user to user. Examples of such variables are specifically those factors that relate to cost as money has a very specific translation.

However, real estate decisions are rarely based on cost alone and other subjective or intangible variables often factor into the decision making process. Building amenities are excellent examples of subjective or intangible variables that might affect a relocation decision. For example, if a user is considering four buildings that have the exact same cost, the decision to move to one building, over another building may be influenced by the fact that one of the buildings has underground, heated parking, a fitness center and community conference room while the three other buildings do not.

In the analysis report, it is typical to present both the quantitative analysis from the landlords' request for proposals (RFP's), as well as a representation of the more subjective building qualities. However, the more subjective variables are usually presented in a list format that simply identifies whether the building has that particular amenity or not. In other words, it is limited to a simple “yes or no” response that does not weigh the user benefit of each particular feature. For example, a user might believe that a building fitness center has much more value than a building conference room. As valuable as a ranking system of this nature might be to the end user, reports still list intangible building qualities as a “yes or no” response and fail to show relative values for any particular building quality or feature. This may be because of variable user preferences. For example, one user might prefer the fitness center over the conference room as mentioned above, and another tenant might prefer the conference room over the fitness center. Because these intangible building qualities range from user to user, it would be remiss of the broker to make arbitrary assumptions on the value of each intangible item for each client they work with or that each client they work with would weigh each item equally.

One solution to this shortcoming might be to conduct a live interview of each client to rank the relative value they put on each subjective building feature. Because of the amount of time required to list building features, perform the live interviews to receive user feedback on relative value, and then analyze the data collected, it would be cost prohibitive to perform such an analysis.

To complicate the analysis process, companies with many national locations have difficulties enforcing their national preferences across all of their locations. For example, a national real estate manager for a company might want their offices to be located in close proximity to public transportation. However, the local branch manager may want the office location that is closest to his/her house, which is contrary to the desire of the national real estate manager. For large corporations, containing cost and delivering consistent work environments is often critical to ensuring financial viability and workforce productivity.

In light of the issues described above, a variable, three-party, request for proposal and proposal analysis system, which allows subjective building feature or qualities analysis automation that is easily customized from user to user, is needed

### BRIEF DESCRIPTION OF THE DRAWINGS

FIG. 1 is a schematic illustrating an embodiment of the system of the present invention;

FIG. 2 is a block diagram illustrating an embodiment of the method of the present invention;

FIG. 3 is an example of a Building Amenities/Services Report that may be produced by an embodiment of the system and method of the present invention;

FIG. 4 is an example of an Agreement to Lease Terms Report that may be produced by an embodiment of the system and method of the present invention.

### DETAILED DESCRIPTION OF EMBODIMENTS

Although the invention is described below in terms of use with leasing in the commercial real estate industry, it could certainly be used for the purchase of real estate or in any other industry where there is an analysis performed and where there is a need to quantify any number of subjective or intangible items that may vary in importance from user to user.

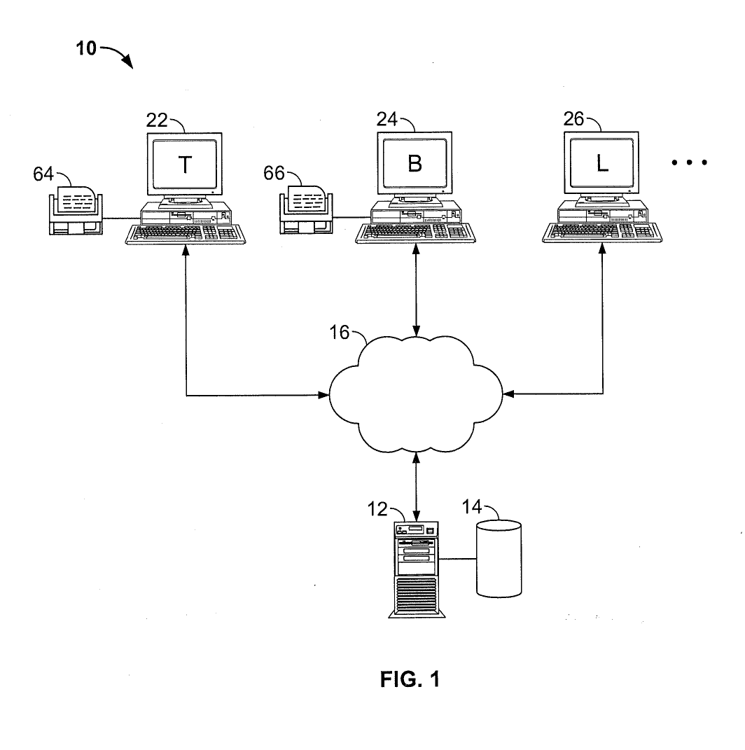

An embodiment of the system of the present invention is indicated in general at 10 in FIG. 1. The system includes a server 12 which hosts a website and associated software with the functionality as described below. The server 12 also includes databases (as indicated at 14 in FIG. 1) and other memory storage with the functionality as described below. A number of workstations communicate with the server 12 via a network such as the Internet 16. The workstations may include a tenant or user's workstation 22 a broker or agents workstation 24 and landlord workstations 26. The server preferably includes four processors, three hard drives configured for RAID 5, a tape backup unit and a file storage module. The server also preferably features multiple connections to the Internet and redundant power sources.

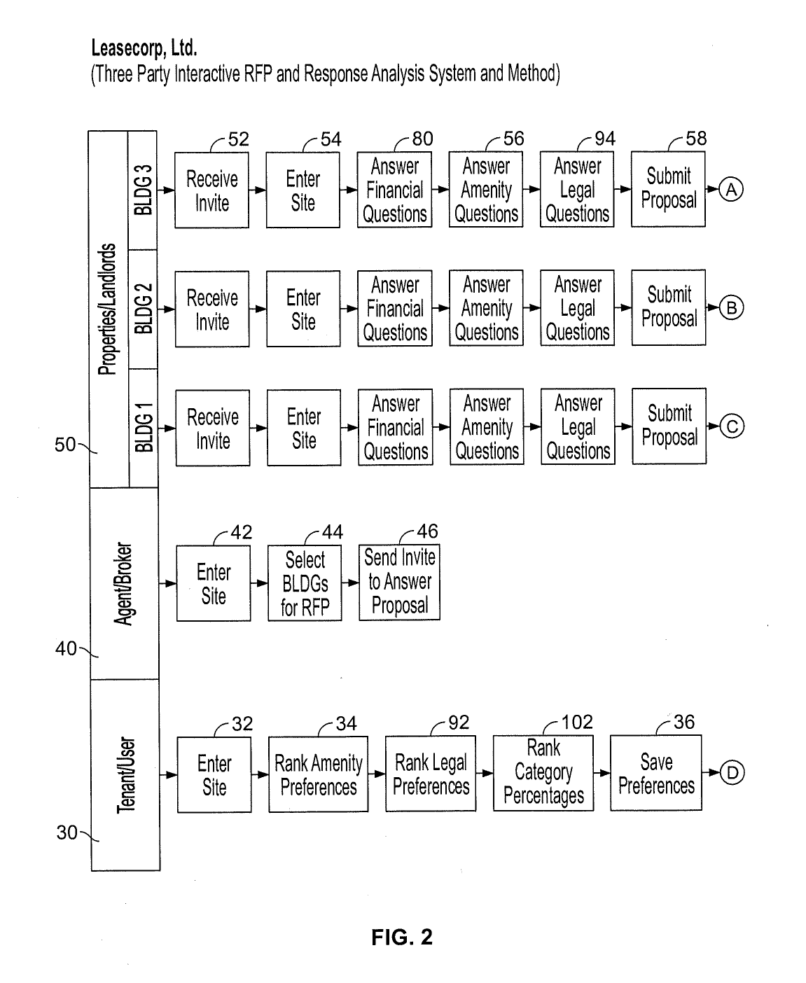

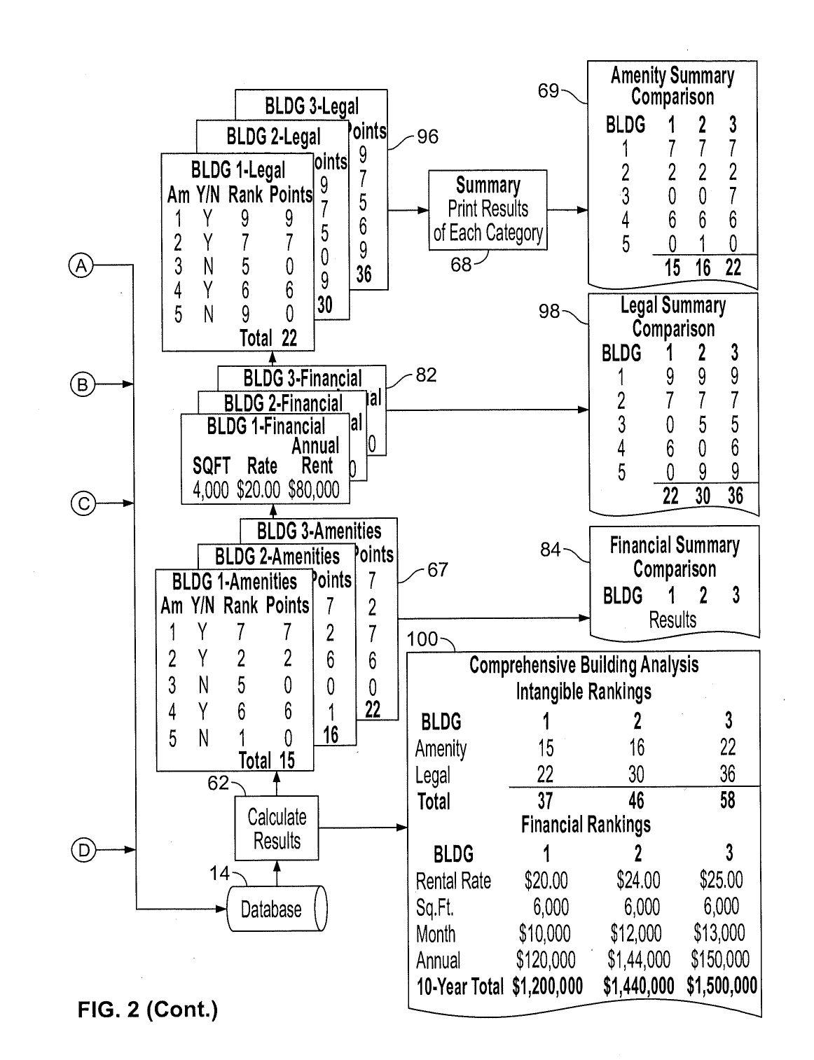

In accordance with Phase I of the invention, indicated at 30 in FIG. 2, a tenant or user of the system enters the website of server 12 using workstation 22 (as indicated at 32 in FIG. 2) and, as indicated at 34, enters or indicates their specific preferences on all subjective building qualities and ranks them based on the value that each building quality/characteristic has to them. For example, a user has an option to put a value of 1 to 10 on whether a prospective building has a fitness center or not. That information is saved (36) and stored in the database 14 of FIGS. 1 and 2.

In accordance with Phase II of the invention, indicated at 40 in FIG. 2, the broker or agent enters the website of server 12 using workstation 24 (as indicated at 42 in FIG. 2) and selects buildings for receiving request for proposals (RFP's) at 44. A list of buildings may be stored on the database 14. The broker then sends an RFP to selected buildings, as indicated at 46. This RFP is preferably consistent with the RFP disclosed in commonly owned U.S. patent application Ser. No. 11/846,149, the contents of which are hereby incorporated by reference, so that complete and accurate information gathered by the RFP is assured. Of course, the system and method of the present invention could be used with RFPs that do not ensure full responses or with a manual (non-electronic) RFP, but the results would not be as accurate or complete.

As indicated at 50, during Phase III, the building landlords receive an invitation to access the website of server 12 via workstations 26, as indicated at 52. Once they accept the invitation and enter the website (54), the landlords receiving the RFP are required to answer “yes or no” questions as to whether their building possesses a list of amenities commonly desired by office tenants and including those ranked by the tenant. The list may be stored on database 14 and may change from time to time based on market demand.

The information entered by each of the building landlords at 56 in FIG. 2 is submitted via the terminal 26 (FIG. 1) and website at 58 (FIG. 2) and, as a result, is entered into the database 14. As indicated at 62 in FIG. 2, the landlord responses gathered in Phase III are cross referenced or compared with the value rankings of each amenity previously entered by the tenant in Phase I by software which may be, for example, loaded on the server 12 of FIG. 1. For each ‘yes’ response, the building receives a value equal to the tenant's ranking for that particular building feature or amenity.

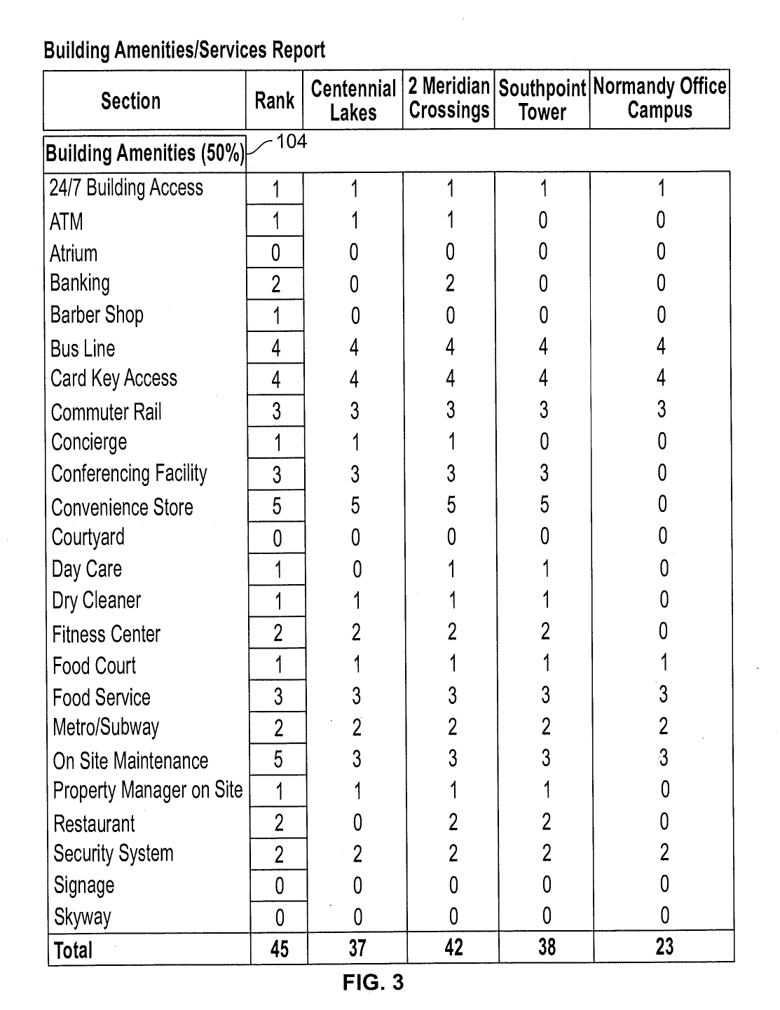

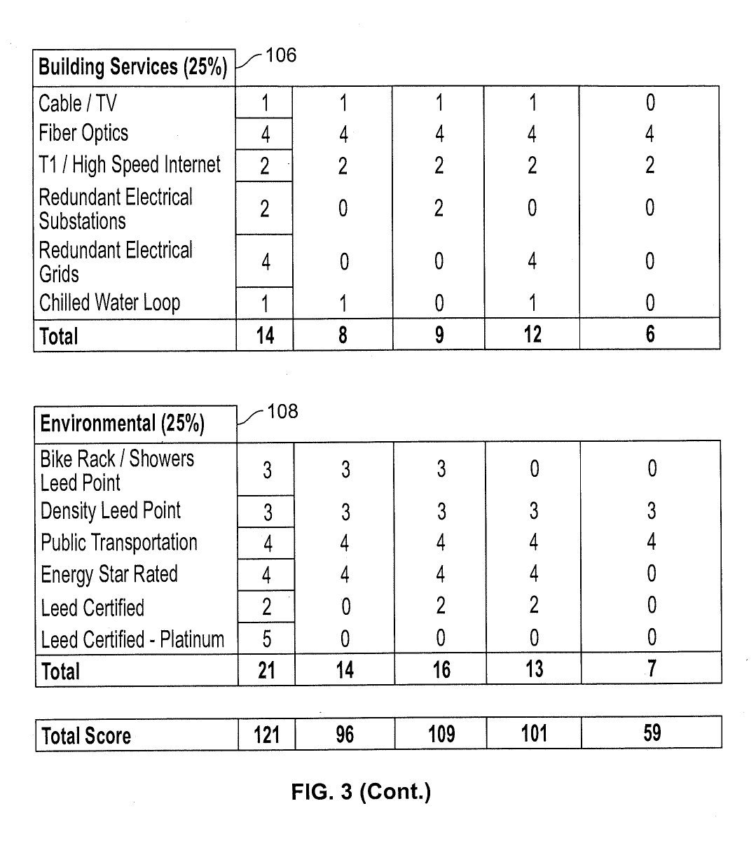

The points awarded for each building are then totaled by the software, as indicated at 67 in FIG. 2. A comprehensive point summary report that lists all of the buildings is than produced by the software, as indicated 68 and 69 in FIG. 2. An example of such a report is provided in FIG. 3. With reference to FIG. 1. the report may be printed out by the tenant via printer 64 or the landlord via printer 66. The comprehensive point total for a particular building is then compared by the tenant and/or broker, or by the software, against the comprehensive point totals from other buildings so that a calculated, quantitative evaluation is made of otherwise subjective or intangible building features.

As indicated at 80 in FIG. 2, each building landlord also provides financial information in response to the REP, such as rent amount and/or other financial information, which is compiled as indicated at 82. This information allows a financial summary comparison report to be produced, as indicated at 84 so that a comparison may be made between buildings on a financial basis.

The process described above for building amenities could alternatively or optionally he run for other intangible or subjective characteristics of buildings. For example, as indicated at 92 in FIG. 2, the tenant ranks preferences with regard to lease agreement legal terms. The RFP provided by the broker to the building landlords during Phase II (40 in FIG. 2) includes a listing of these lease agreement legal terms and the building landlords are required to answer “yes or no” questions as to whether they accept each term (94). This information is entered into the database 14 and the landlord responses gathered in Phase III at 94 are cross referenced by software at 62 with the value rankings of each lease term previously entered by the tenant at 92 in Phase I. For each ‘yes’ response, the building receives a value equal to the tenant's ranking for that particular lease term.

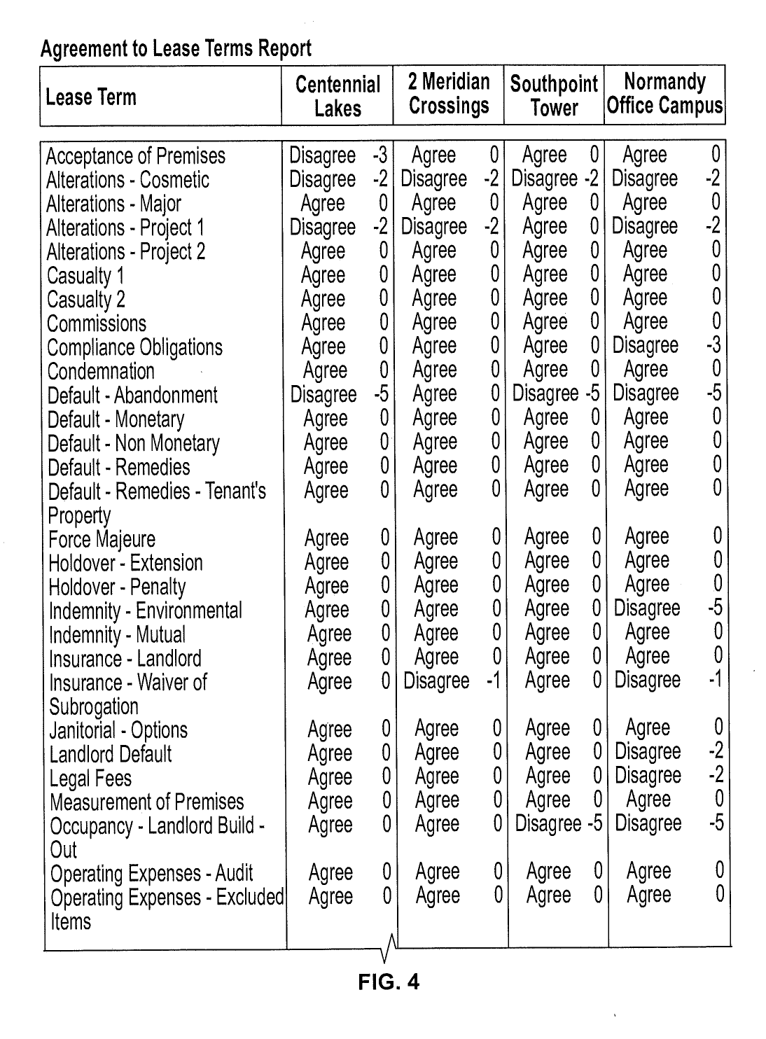

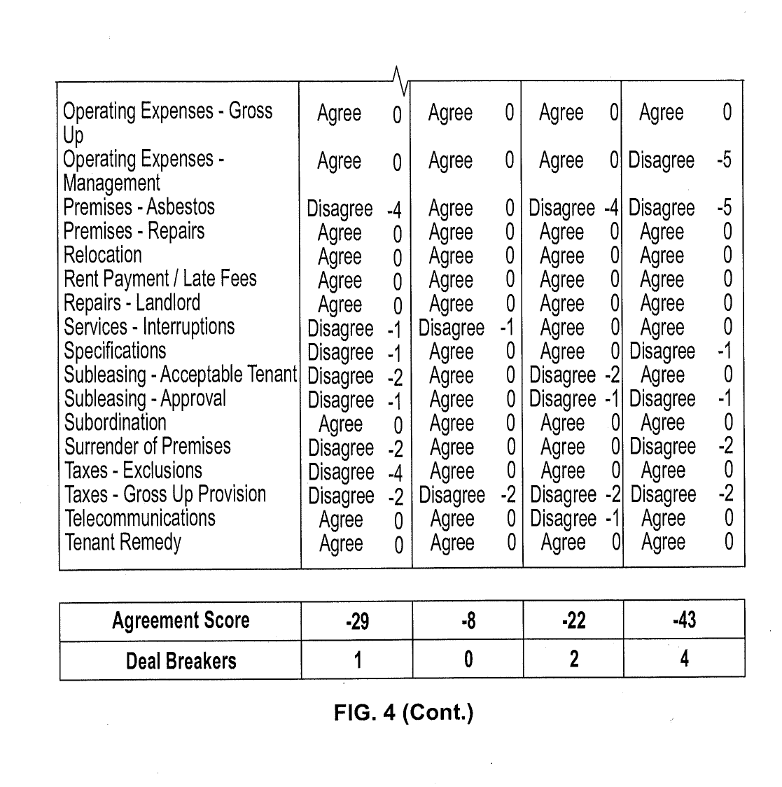

The points awarded for each building are then totaled by the software, as indicated at 96 in FIG. 2, to provide a score. A comprehensive point summary report that lists all of the buildings is then produced by the software, as indicated 68 and 98 in FIG. 2. An example of such a report is provided in FIG. 4. Of course, this report may also be printed out by the tenant via printer 64 or the landlord via printer 66. The comprehensive point total or score for a particular building is then compared by the tenant and/or broker, or by the software, against the comprehensive point totals from other buildings so that a calculated, quantitative evaluation is made based on all subjective and objective lease terms acceptable to each building.

As indicated at 100 in FIG. 2, the points for each intangible or subjective category for each building may be added to provide an overall intangible ranking for each building. The financial rankings for the buildings may also be included on this report (again, as illustrated at 100 in FIG. 2).

Examples of other comparisons and reports include, but are not limited to, ‘building location preferences’, ‘building sustainability’, ‘building services’, ‘environmental considerations’ and the like. Indeed, examples of Building Services and Environmental scores and totals are also provided in the report of FIG. 3.

Furthermore, as indicated at 102 in FIG. 2, for each category assessed, a similar ranking system is preferably applied to consider the totality of ail factors considered whereby a tenant or user also ranks which of the categories is most valuable to them. For example, with reference to fields 104, 106 and 108 of the report of FIG. 3, one user might place 50% of the weight on Building Amenities and 25% each on Building Services and Environmental while another user might put 75% on Financial, 25% on Amenities and 0% on Environmental.

Using the above embodiment of the system and method of the invention, it is clear to see that a multi-building analysis would return quite different results and recommendations to end users that had different rankings of various building features and amenities, not only producing an automated analysis customized specifically for a particular user, but also an analysis that quantifies a list (or lists) of previously perceived intangible items.

While the preferred embodiments of the invention have been shown and described, it will be apparent to those skilled in the art that changes and modifications may he made therein without departing from the spirit of the invention, the scope of which is defined by the appended claims.

What is claimed is:

1. An interactive request for proposal and response analysis system comprising:
a. a user workstation;
b. an agent workstation;
c. at least one landlord workstation;
d. at least one database upon which is stored a list of subjective characteristics relating to buildings;
e. a server in communication with the user, agent and landlord workstations and the at least one database;
f. said server having software for a website whereby:
i) a user may use the user work station to access the list of subjective characteristics and enter user specific preferences for at least some of the subjective characteristics, where the entered user specific preferences are stored on the database;
ii) an agent may use the agent workstation to select to plurality of buildings for receiving requests for proposals, where the requests for proposals each includes the list of subjective characteristics, and send the requests for proposals to landlords for the plurality of buildings;
iii) the landlords may use the at least one landlord workstation to receive and access the requests for proposals and each landlord may enter a response for each subjective characteristic, where the entered responses for the subjective characteristics are stored on the database;
iv) the entered user specific preferences are compared with the entered landlord responses for the subjective characteristics for each of the plurality of buildings and a score is calculated for each building based on the comparison.

2. The system of claim 1 wherein the user and the agent are different individuals and the user workstation and the agent workstation are different workstations.

3. The system of claim 1 wherein the list of subjective characteristics includes building amenities.

4. The system of claim 1 wherein the list of subjective characteristics includes lease agreement legal trims.

5. The system of claim 1 wherein the list of subjective characteristics includes building services.

6. The system of claim 1 wherein the list of subjective characteristics includes environmental information.

7. The system of claim 1 wherein the request for proposal includes a request for financial information that is entered by the landlord.

8. The system of claim 1 wherein the database stores a list of buildings from which the plurality of buildings is selected.

9. The system of claim 1 wherein the list of subjective characteristics includes first and second categories of subjective characteristics and the user enters a user specific preference for each of the first and second categories.

10. A method for collecting and analyzing preferences for subjective characteristics relating to buildings comprising the steps of:
a. providing a computer system including a user workstation, an agent workstation, at least one landlord workstation, at least one database upon which is stored a list of subjective characteristics relating to buildings, and a server in communication with the user, agent and landlord workstations and the at least one database;
b. accessing the list of subjective characteristics using the user workstation;
c. receiving user specific preferences for at least some of the subjective characteristics using the user workstation;
d. storing the entered user specific preferences on the database;
e. selecting a plurality of buildings using the agent workstation;
f. sending requests for proposals to landlords for the plurality of buildings using the agent workstation, where the requests for proposals each includes the list of subjective characteristics;
g. receiving the requests for proposals using the at least one landlord workstation;
h. receiving a response for each subjective characteristic using the at least one landlord workstation;
i. storing the entered responses for the subjective characteristics on the database;
j. comparing the stored user specific preferences with the stored landlord responses for the subjective characteristics for each of the plurality of buildings; and
k. calculating a score for each building based on the comparison of step j.

11. The method of claim 10 wherein the user workstation and the agent workstation are different workstations.

12. The method of claim 10 wherein the list of subjective characteristics includes building amenities.

13. The method of claim 10 wherein the list of subjective characteristics includes lease agreement legal terms.

14. The method of claim 10 wherein the list of subjective characteristics includes building services.

15. The method of claim 10 wherein the list of subjective characteristics includes environmental information.

16. The method of claim 10 wherein the request for proposal includes a request for financial information that is entered.

17. The method of claim 10 wherein the database stores a list of buildings from which the plurality of buildings is selected.

18. The method of claim 10 wherein the list of subjective characteristics includes first and second categories of subjective characteristics and the further comprising the step of entering a user specific preference for each of the first and second categories.

19. A machine-readable non-transitory medium on which has been pre-recorded a computer program which, when executed by a processor, performs the following steps:
a. accesses a list of subjective characteristics;
b. receives user specific preferences for at least some of the subjective characteristics;
c. stores the entered user specific preferences on a database;
d. selects a plurality of buildings;
e. sends requests for proposals to landlords for the plurality of buildings, where the requests for proposals each includes the list of subjective characteristics;
f. receives and displays the requests for proposals;
g. receives a response for each subjective characteristic in the requests for proposals;
h. stores the entered responses for the subjective characteristics on the database;
i. compares the stored user specific preferences with the stored landlord responses for the subjective characteristics for each of the plurality of buildings; and
j. calculates a score for each building based on the comparison of step i.

20. The machine-readable non-transitory medium of claim 19 wherein the list of subjective characteristics includes first and second categories of subjective characteristics and the further comprising the step of receiving a user specific preference for each of the first and second categories.
